(19) United States
(12) Patent Application Publication
(10) Pub. No.: US 2006/0177668 A1
(43) Pub. Date: Aug. 10, 2006

(54) Resin material molding method, resin material molding apparatus and molded article

(75) Inventors: Shingo Asai, Toyokawa-shi (JP); Akihiko Matsumoto, Toyokawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/344,146

(22) Filed: Feb. 1, 2006

(30) Foreign Application Priority Data
Feb. 9, 2005 (JP) 2005-032455

(51) Int. Cl. B29C 47/00; B32B 27/00; B32B 27/32; B32B 27/30; B32B 27/36

(52) U.S. Cl. 428/411.1; 425/130; 264/40.1; 264/173.16; 264/328.8; 428/412; 428/500; 428/522; 428/523

(57) ABSTRACT

A resin material molding method includes: equalizing flow speeds of a first resin material and a second rein material at a confluence of the resin materials when the first material and the second resin material are fed into a common cavity through different inlets, the cavity including a first mold and a second mold.

### BACKGROUND OF THE INVENTION

1. Field of the Invention

The present invention relates to a resin material molding method and a resin material molding apparatus which can, for example, form a high-performance resin article, and a molded article formed by the above method or apparatus.

2. Description of the Related Art

Injection-molded articles have been used in various fields in recent years and a wide range of injection molding techniques has been developed accordingly. One of the techniques focuses on characteristics of individual resin materials and bonds a plurality of different resin materials together in order to create products with higher added-values. Sticking injection-molded articles together may be one way to obtain such products. However, bonding a plurality of resin materials together at a stage of injection molding is easier in obtaining aforementioned high-value-added products. Insert molding and co-injection molding are known as such methods for forming injection-molded articles using a plurality of resin materials.

However, insert molding has a problem in that complex manufacturing processes are required because after one resin material is molded first, the molded resin material is then placed on a mold to feed the other molten resin material so that two resin materials are bonded together. Co-injection molding, in which a plurality of resin materials are injected alternately from different injection cylinders, also has a problem in that bonding strength between resin materials is generally low.

In order to solve these problems, a simultaneous composite injection molding method is disclosed in “Fundamental Study of Two Layer Molding by Simultaneous Composite Injection Molding” by Shingo Asai et al., Journal of the Japan Society of Polymer Processing, Vol. 16, No. 12, 2004. In this method, resin materials are injected into one mold cavity simultaneously from two injection cylinders to create a molded article.

According to the technique disclosed in the above document, a molded article can be produced by developing different resin materials without allowing them to mix. However, further devices are still necessary for higher bonding strength between different resin materials and also for changes in a thickness ratio between different resin materials.

### SUMMARY OF THE INVENTION

The present invention has been accomplished in the light of the abovementioned problems, and an object thereof is to provide a resin material molding method which enables a plurality of resin materials to be bonded together with high strength in a simple process, and a molded article. Another object of the present invention is to provide a resin material molding apparatus which enables a plurality of resin materials to be bonded together at different thickness ratios.

In order to address the aforementioned problems, according to a first aspect of the present invention, a resin material molding method comprises: equalizing flow speeds of a first resin material and a second rein material at a confluence of the resin materials when the first material and the second resin material are fed into a common cavity through different inlets, the cavity including a first mold and a second mold.

The principle of the present invention is described with reference to the drawings. FIGS. 1A to 1C are views explaining the principle of the present invention, schematically depicting flows of resin materials. FIG. 2 is a cross-sectional view schematically showing a molded article formed in accordance with the present invention. As shown in FIGS. 1A to 1C, a cavity C is formed between an upper mold M1 and a lower mold M2 which have a casing-like shape. This common cavity C has an opening OP and a partition plate PT is placed within the opening OP. The opening OP is divided into a first inlet G1 and a second inlet G2 by the partition plate PT. Here, the first inlet G1 and the second inlet G2 have the same area in minimum cross section, and the first resin material PL1 and the second resin material PL2 fed through the inlets have the same temperature and pressure.

During injection molding or extrusion molding, the first resin material PL1 in a molten state is fed from a hopper (not shown) into the cavity C through the first inlet G1, and the second resin material PL2 in a molten state is fed from another hopper into the cavity C through the second inlet G2. In this case, as shown in FIGS. 1A to 1C, the first resin material PL1 and the second resin material PL2 gradually spread in layers within the cavity C as the resin materials are fed. At this time, where the first resin material PL1 and the second resin material PL2 have the same speed at a first confluence A of them (in this case, the side end of the partition plate PT on the side of the cavity C), surfaces of the first resin material PL1 and the second resin material PL2 which face one other do not move relatively to each other as shown in FIG. 1A. Therefore, a non-directed layer NDL is formed instead of a directed layer. Further, as shown in FIGS. 1B and 1C, once the non-directed layer NDL is formed, it is never destroyed even if the first resin material PL1 and the second resin material PL2 are further fed to the cavity C. After the developed resin materials PL1 and PL2 are solidified, the upper mold M1 and the lower mold M2 are removed, and a molded article shown in FIG. 2 is obtained. There, the “directed layer” represents a layer of a resin flow generated when a molten resin material contacts a different material while moving relatively to it. The “non-directed layer” represents a layer without any resin flow.

For example, since the first resin material PL1 moves relatively to the inner surface of the upper mold M1, a directed layer DL showing a resin material flow in a predetermined (in this case, horizontal) direction is formed. Similarly, since the second resin material PL2 moves relatively to the inner surface of the lower mold M2, a directed layer DL showing a resin material flow in a predetermined (in this case, horizontal) direction is formed.

As for the non-directed layer NDL formed in a portion of the first resin material PL1 facing the second resin material PL2 and the same formed in a portion of the second resin material PL2 facing the first resin material PL1, the molecules of the first and second resin materials PL1 and PL2 are both embedded in the non-directed layers NDL on the other sides. This results in the characteristics of extremely high bonding strength of the two materials after solidification.

Further, this method realizes simple manufacturing process as compared with a process of insert molding or a process in which an adhesive is used.

Therefore, according to the present invention, a molded article having strong bonding strength can be produced with a simple process. Note that the phrase “equalizing flow speeds” does not necessarily mean that flow speeds have to be strictly identical, and some speed differences are acceptable as long as they are small enough to prevent a directed portion from being generated.

According to a second aspect of the present invention, a resin material molding method comprises: controlling a thickness ratio of a first resin material to a second resin material in a direction perpendicular to a flow direction by changing at least one of temperature, pressure and speed of the first resin material and the second resin material in a common cavity when the first resin material and the second resin material are fed into the common cavity through different inlets, the cavity including a first mold and a second mold.

The principle of the present invention is described with reference to the drawings. FIGS. 3A to 3C are views for explaining the principle of the present invention, schematically depicting resin flows. FIGS. 3A to 3C are different from FIGS. 1A to 1C in that the first resin material PL1 in a first inlet G1 has a pressure P1 and a second resin material PL2 in a second inlet G2 has a pressure P2 which is lower than P1 (P1>P2).

As described above, when the pressure P1 of the first resin material PL1 is larger than the pressure P2 of the second resin material PL2, the volume of the first resin material PL1 that fills the common cavity C is larger than that of the second resin material PL2 as shown in FIGS. 3A to 3C. However, by equalizing the speeds of both resin materials at the confluence, the first and second resin materials PL1 and PL2 are developed and fill the cavity C at the same speed. As a result, as shown in FIG. 3C, the thickness (in a direction perpendicular to the flow direction) t1 of the first resin material PL1 is larger than the thickness t2 of the second resin material PL2. In other words, by setting the pressure P1 of the first resin material PL1 and the pressure P2 of the second resin material PL2 at arbitrary values, the thickness ratio (t1/t2) can be set at an arbitrary value. It should be apparent that the thickness ratio can also be controlled by changing the temperature (thus viscosity) or speeds of the first resin material PL1 and the second resin material PL2.

In the resin material molding method according to the present invention, it is preferred that the first resin material and the second resin material be the same material. In this case, a thick molded article can be formed. When a partially thick molded article is formed by injection molding or extrusion molding, a problem such as a sink occurs, and birefringence of bonded surfaces may change. Hence, such molded articles are sometimes not suitable for optical elements. Nevertheless, according to the present invention, by bonding the first resin material and the second resin material made from the same material, a problem such as a sink can be avoided. Particularly, the bonding strength is further enhanced by forming a non-directed portion in the bonded part of the first resin material and the second resin material, and changes in birefringence is prevented in the non-directed portion. Accordingly, it becomes possible to obtain a thick and sink-free molded article whose strength characteristics (elastic modulus) and birefringence are just like those of a thin molded article formed by injection molding or extrusion molding using a single resin material.

Moreover, in the resin material molding method according to the present invention, it is also preferred that the first resin material and the second resin material be different materials. In this case, a molded article having characteristics of both the first resin material and the second resin material can be obtained. Alternatively, in a case of forming an external plate of an apparatus, it is also possible to use a recycled resin material (for example, the second resin material) for the inner portion which cannot be seen by a user, and a new material (for example, the first resin material) for the outer portion. Thus, a low-cost and environmentally-friendly molded product can be formed.

Further, in the resin material molding method according to the present invention, it is preferred that the first resin material and the second resin material be at least, but not limited to, any one of PC, ABS, modified PPE, PBT, PCABS, PCPBT, HIPS, polyamide, POM, PP, PMMA, COP and COC.

Furthermore, in the resin material molding method according to the present invention, it is also preferred that the first resin material and the second resin material contains at least one of a glass fiber, a glass bead, or a carbon fiber. In this case, a strong molded article can be formed. Note that, a compatibilizer, an emulsifier, a mold release lubricant and the like can be mixed arbitrarily.

Yet further, in the resin material molding method according to the present invention, it is preferred that different inlets be formed by dividing a single inlet with a partition plate, the single inlet being connected to the cavity, that the partition plate be cylindrical, that the first resin material flow through the inlet on the radial outer side of the partition plate, and that the second resin material flow through the inlet on the radial inner side of the partition plate.

FIG. 4 is a perspective view showing the partition plate according to the present invention. In FIG. 4, a small cylinder CY2 is placed in a large cylinder CY1. A cylindrical space (the single inlet) OP is created between the large cylinder CY1 and the small cylinder CY2 and its front end in FIG. 4 is connected to the non-illustrated cavity (in this case, a hollow cylindrical shape is preferred) and the other end thereof is closed. The cylindrical partition plate PT is placed in the space OP, dividing the space OP into a radial outer space and a radial inner space. The outer space (referred to as a first inlet G1) between the large cylinder CY1 and partition plate PT is communicated with a first passage PS1 connected to a hopper of the first resin material PL1. The inner space (referred to as a second inlet G2) between the partition plate PT and the small cylinder CY1 is communicated with a second passage PS2 connected to a hopper of the second resin material PL2.

During injection molding or extrusion molding, the first resin material PL1 in a molten state is fed into the cavity from the hopper through the first passage PS1 and the first inlet G1, and the second resin material PL2 in a molten state is fed into the cavity from another hopper through the second passage PS2 and the second inlet G2. Accordingly, a cylindrical resin molded article having the first resin material PL1 formed as the outer layer of the circumference and the second resin material PL2 formed as the inner layer of the circumference can be obtained. Note that the shapes of the large cylinder CY1, the small cylinder CY2, and the partition plate PT are not limited to a cylindrical shape but can be an angular-pipe shape.

According to a third aspect of the present invention, a resin material molding apparatus comprises:

a first mold and a second mold for creating a cavity inside;

a first feed source for feeding a first resin material to the cavity;

a first passage for connecting the first feed source and the cavity;

a second feed source for feeding a second resin material to the cavity;

a second passage for connecting the second feed source and the cavity; and

a partition plate for dividing off the first passage from the second passage before the cavity, wherein the first resin material and the second resin material flow together at a position beyond the partition plate, and the partition plate is provided so as to be displaced at least in a direction perpendicular to flows of the first resin material and the second resin material.

The principle of the present invention is described with reference to drawings. FIGS. 5A and 5B are schematic views showing an example of the resin material molding apparatus of the present invention. In FIGS. 5A and 5B, a cavity C is formed between an upper mold (also referred to as a first mold) M1 and a lower mold (also referred to as a second mold) M2 which have a casing-like shape and can be separated from each other. This common cavity C has an opening OP, which is connected to a first hopper (also referred to as a first feed source) H1 through a first passage PS1, and to a second hopper (also referred to as a second feed source) H2 through a second passage PS2.

Within the opening OP1, a partition plate PT is placed at the confluence of the first passage PS 1 and the second passage PS2. The opening OP is divided into a first inlet G1 and a second inlet G2 by the partition plate PT. The other end (the right end in FIGS. 5A and 5B) of the partition plate PT is extended to the outside of the first passage PS1 or the second passage PS2 and is screwed with a threaded shaft SW there. The threaded shaft SW is rotated by a motor M. As the threaded shaft SW is rotated, the partition plate PT moves laterally in FIGS. 5A and 5B. In the state shown in FIG. 5A, the partition plate PT is placed in the middle, so the height of the first inlet G1 and that of the second inlet G2 are equal. In a state shown in FIG. 5B, the partition plat PT is moved downward, so the second inlet G2 is lower than the first inlet G1.

When injection molding or extrusion molding is carried out in a state shown in FIG. 5A, the first resin material PL1 in a molten state is fed into the cavity C from the hopper Hi through the first passage PS1 and the first inlet G1, and the second resin material PL2 in a molten state is fed into the cavity C from the hopper H2 through the second passage PS2 and the second inlet G2. At this time, as shown in FIG. 5A, the first resin material PL1 and the second resin material PL2 meet at a position A beyond the partition plate PT (in other words, at the side end of the partition plate PT on the side of the cavity C) as they are fed into the cavity C, and, the materials gradually spread in layers within the cavity C. By equalizing the speed of the first resin material PL1 with the second resin material PL2 at the first confluence, the bonding portion of the first resin material PL1 and the second resin material PL2 becomes a non-directed layer NDL as described earlier with reference to FIGS. 1A to 1C, thus making it possible to obtain a resin molded article with desired characteristics. In this case, the resin materials PL1 and PL2 develop and fill the cavity C at an equal ratio. Therefore, as shown in FIG. 5A, the thickness (a thickness in a direction perpendicular to the flow direction) t1 of the first resin material PL1 and the thickness t2 of the second resin material PL2 become equal.

When injection molding or extrusion molding is carried out in a state shown in FIG. 5B where the position of the partition plate PT is changed, the first resin material PL1 and the second resin material PL2 also meet at the position A beyond the partition plate PT as they are fed into the cavity C, and then gradually spread in layers within the cavity C. However, the volume of the first resin material PL1 filling the cavity C is larger than that of the second resin material PL2. Further, by equalizing the speeds of the both materials at the confluence, the materials PL1 and PL2 develop and fill the entire cavity C at the same speed. As a result, as shown in FIG. 5B, the thickness t1 of the first rein material PL1 becomes larger than the thickness t2 of the second resin material PL2. In other words, by displacing the partition plate PT in the direction perpendicular to the flow of the resin materials, the thickness ratio (t1/t2) can be set at an arbitrary value. Note that the partition plate PT can be displaced during a molding process instead of being fixed, so a molded material having different thicknesses of the resin materials as desired can be obtained.

In the resin material formation apparatus according to the present invention, it is preferred that the partition plate be separated from the first mold and the second mold.

Further, in the resin material formation apparatus according to the present invention, it is preferred that the partition plate be integrated with the first mold or the second mold.

According to a fourth aspect of the present invention, a molded article is one in which a first resin material and a second resin material are bonded together, and non-directed layers are formed at least in the second resin material facing the first resin material and in the first resin material facing the second rein material.

As shown in FIG. 2, in the non-directed layers NDL formed in a portion of the first resin material PL1 facing the second resin material PL2 and in a portion of the second resin material PL2 facing the first resin material PL1, the molecules of the first and second resin materials PL1 and PL2 are both embedded in the non-directed layers NDL on the other sides. This results in characteristics of extremely high bonding strength of the two materials after solidification. In other words, according to the present invention, a molded article in which the first resin material PL1 and the second resin material PL2 are bonded together with high strength can be obtained through, for example, a molding process, without depending on an adhesive or the like.

Moreover, a manufacturing process can be simplified as compared with a process of insert molding or a process in which an adhesive is used.

According to a fifth aspect of the present invention, a molded article is one in which a first resin material and a second resin material are bonded together, and three non-directed layers which are sandwiched by directed layers, are formed within the molded article.

As shown in FIG. 2, a non-directed layer NDL(1) is formed on a border between a first resin material PL1 and a second resin material PL2. Meanwhile, directed layers DL(1) are formed on both sides of the non-directed layer NDL(1) in a direction perpendicular to the flows of the resin materials since there are relative movements of the resin materials. On the outer sides of the directed layers DL(1), where there is no relative movement of the resin materials, non-directed layers NDL(2) are formed. Meanwhile, there are relative movements of the resin materials between the non-directed layers NDL(2) and the first mold M1 and the second mold M2 (see FIGS. 1A to 1C). Therefore, directed layers DL(2) are formed. Accordingly, a molded article having the first resin material PL1 and the second resin material PL2 bonded together and formed by, for example, the foregoing molding method, includes three non-directed layers NDL each being sandwiched by directed layers DL. Among the three non-directed layers NDL, one in the middle NDL(1) is made of the molecules of the first resin material PL1 and the second resin material PL2 that are embedded into each other, and thus has extremely high bonding strength after solidification of the resin materials.

In the molded article according to the present invention, it is preferred that the first resin material and the second resin material be the same material.

In the molded article according to the present invention, it is also preferred that the first resin material and the second resin material be different materials.

Further, in the molded article according to the present invention, it is preferred that the first resin material and the second resin material be at least any one of PC, ABS, modified PPE, PBT, PCABS, PCPBT, HIPS, polyamide, POM, PP, PMMA, COP and COC.

Furthermore, in the molded article according to the present invention, it is preferred that the first resin material and the second resin material contain at least one of a glass fiber, a glass bead, and a carbon fiber.

Yet further, it is preferred that the molded article according to the present invention have a film shape.

Yet further, it is preferred that the molded article according to the present invention is cylindrical.

Yet further, it is preferred that the molded article according to the present invention is an optical element. In a case where the molded article according to the present invention is a chromatic aberration correcting lens, gradient index lens or the like, the molded article can be manufactured at lower cost with fewer manufacturing processes than those for a conventional molded article. In addition, since molding shrinkage of the first resin material PL1 and the second resin material PL2 occurs simultaneously, a warp and an internal stress are reduced, thus realizing an optical element with high accuracy and high bonding strength. In a case where the molded article according to the present invention is a thick lens, molding shrinkage of the first resin material PL1 and the second resin material PL2 occurs simultaneously, thus reducing a warp and an internal stress. Therefore, the lens is provided with not only high accuracy and high bonding strength but also fewer sinks and excellent birefringence. Note that the molded article of the present invention may also be used as a temperature correcting lens, a moisture absorption correcting lens, a light-proof lens and the like, by making use of different characteristics of the first resin material and the second resin material. Further, apart from an optical article, the molded article according to the present invention may also be applied to various products such as a covering member, a shell member, an intermediate transfer belt, a fixing belt, a liquid crystal film and the like for a printer or a photocopy machine.

### BRIEF DESCRIPTION OF DRAWINGS

The present invention will become more fully understood from the detailed description given hereinafter and the accompanying drawings given by way of illustration only, and thus are not intended as a definition of the limits of the present invention, and wherein:

FIGS. 1A to 1C are views for explaining the principle of the present invention, schematically showing flows of resin materials;

FIG. 2 is a cross-sectional view schematically showing a molded article formed in accordance with the present invention;

FIGS. 3A to 3C are views for explaining the principle of the present invention, schematically showing flows of resin materials;

FIG. 4 is a perspective view showing a partition plate according to the present invention;

FIGS. 5A and 5B are schematic views showing an example of a resin material molding apparatus according to the present invention;

FIG. 6 is a schematic structural view of a resin molding apparatus according to an embodiment;

FIG. 7 is an enlarged view of a cross section of a molded article along the resin flow direction, the molded article being actually formed using the molding apparatus shown in FIG. 6; and

FIG. 8 is an enlarged view of a cross section of a molded article along the resin flow direction, the molded article being actually formed using the molding apparatus shown in FIG. 6.

### PREFERRED EMBODIMENT OF THE PRESENT INVENTION

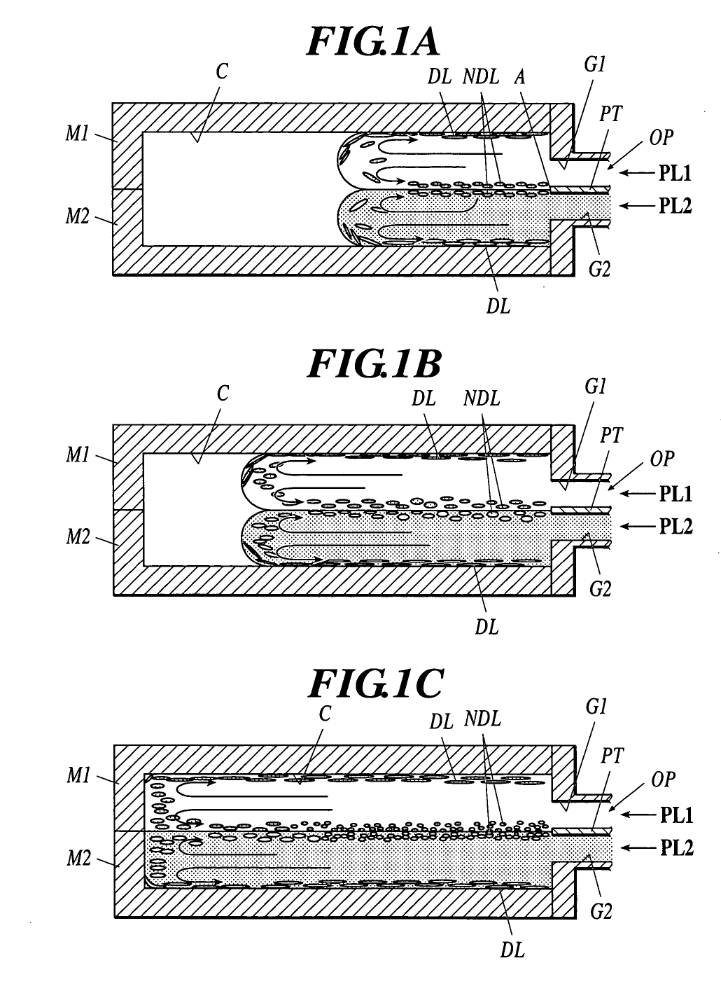

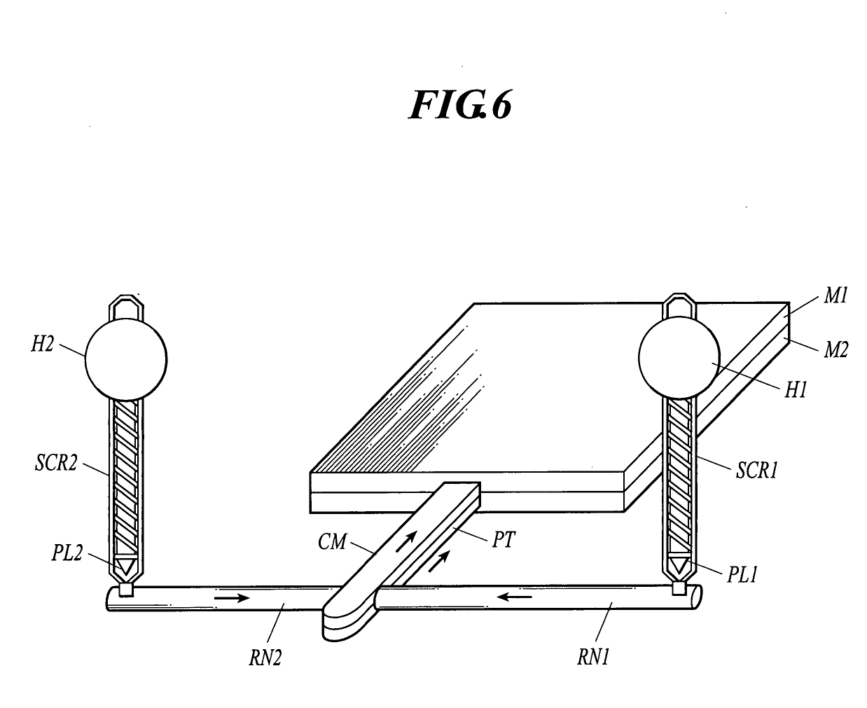

Hereinafter, an embodiment of the present invention is described with reference to the drawings. FIG. 6 is a schematic structural view of a resin material molding apparatus according to the embodiment. A pipe member CM, internal space of which is divided by a partition plate PT in the middle, is communicated with a cavity (not shown) formed between a first mold M1 and a second mold M2. The upper space (a first inlet) in the pipe member CM created by the partition plate PT is connected to a runner RN1 serving as a first passage. The lower space (a second inlet) in the pipe member CM created by the partition plate PT is connected to a runner RN2 serving as a second passage. A first resin material PL1 extruded by a first screw SCR1 from a first hopper Hi, acting as a first feed source, gradually fills the inside from the end of the runner RN1. A second resin material PL2 extruded by a second screw SCR2 from a second hopper H2, acting as a second feed source, gradually fills the inside from the end of the runner RN2. The relation between the cavity and the partition plate PT is similar to that shown in FIGS. 1A to 1C and the like.

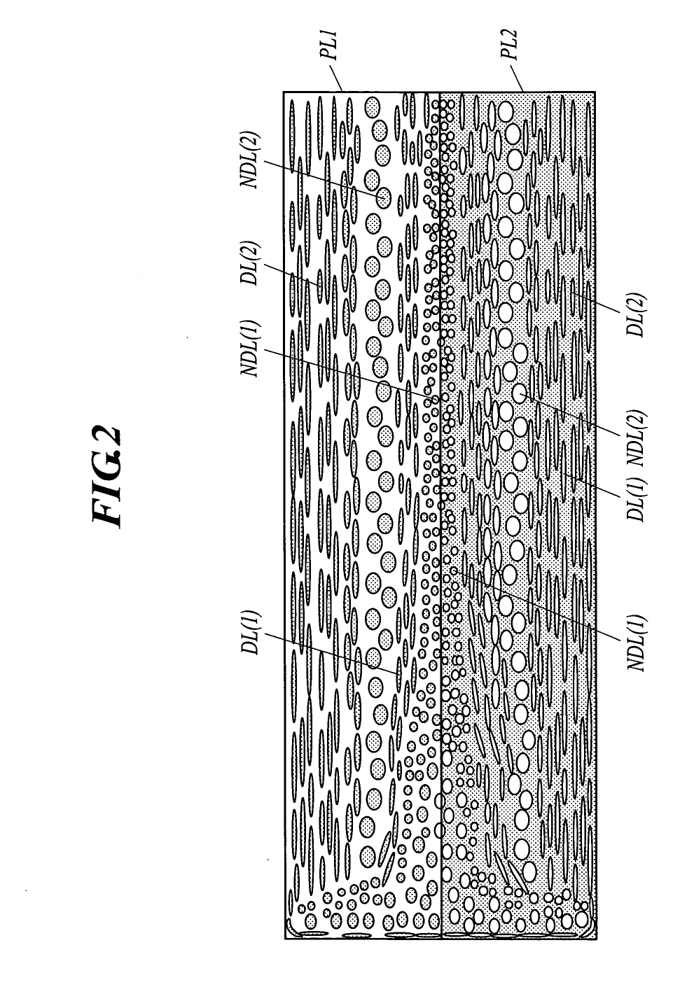

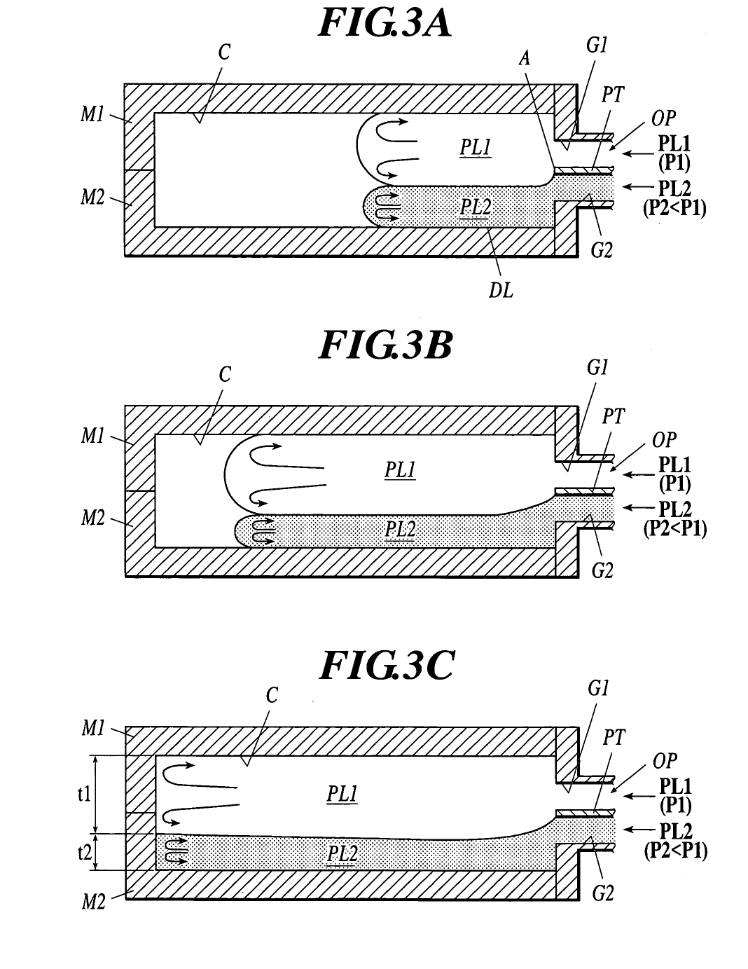

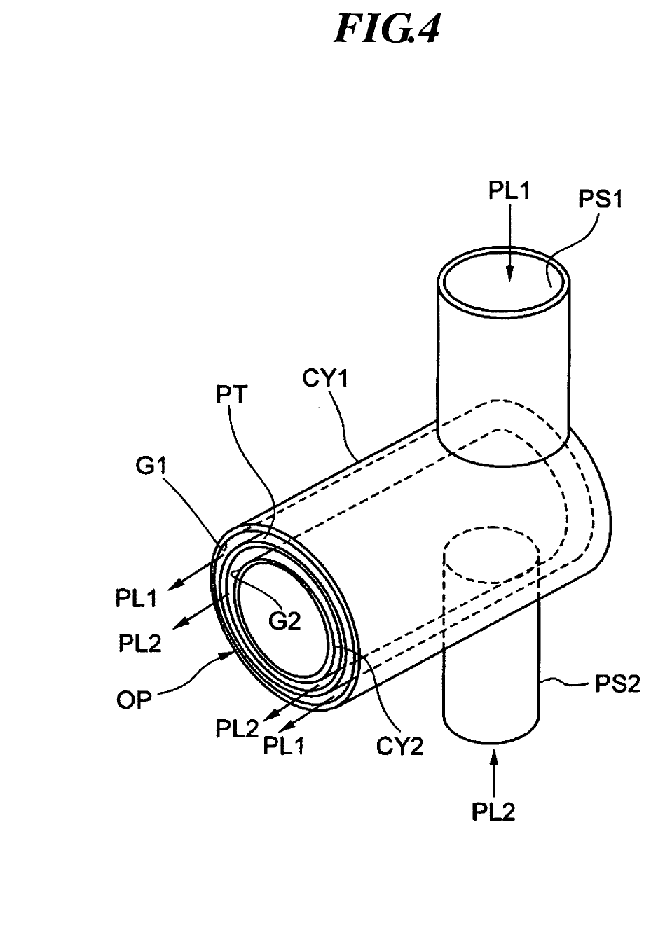

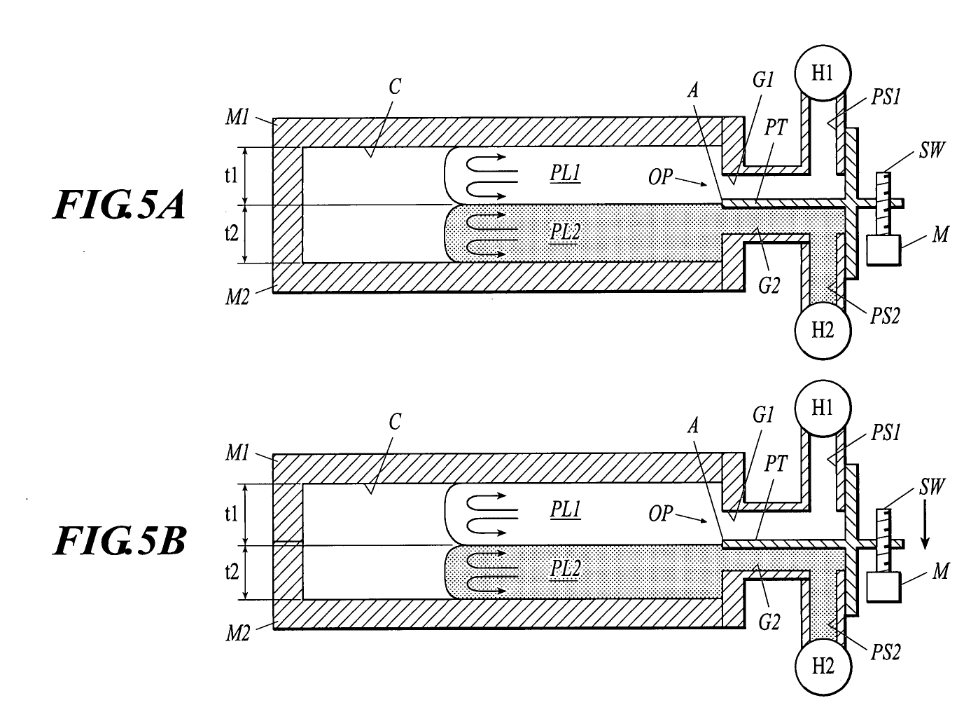

During extrusion molding, the first resin material PL1 in a molten state is extruded by the first screw SCR1 from the first hopper Hi and fed into the cavity through the runner RN1 and the first inlet. At the same time, the second resin material PL2 in a molten state is extruded by the second screw SCR2 from the second hopper H2 and fed into the cavity through the runner RN2 and the second inlet. The important point here is that, although a distance between the cavity and the first screw SCR1 and a distance between the cavity and the second screw SCR2 can be different, the first resin material PL1 and the second resin material PL2 to be fed into the cavity must have the same timing and speed at the confluence of the resin materials at the side end of the partition plate PT on the side of the cavity. Therefore, the resin material molded article as shown in FIG. 2 can be obtained.

Note that feed temperature of resin materials is preferably 200 degrees centigrade or lower for ABS, 270 degrees centigrade or lower for an admixture of PC and ABS, 300 degrees centigrade or lower for PC, and 270 degrees centigrade or lower for PMMA. The viscosity is preferably 5×10²Pa•S or lower. Further, a difference in temperature between the first resin material PL1 and the second resin material PL2 is preferably 30 degrees centigrade or smaller. Moreover, feeding speed of the resin materials is preferably not more than 50 mm/sec at the screw moving speed of the molding apparatus.

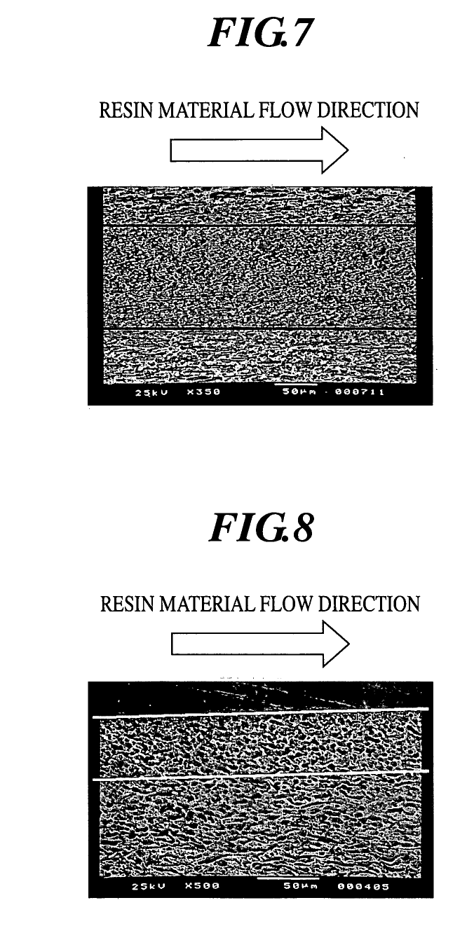

FIGS. 7 and 8 are enlarged views of cross sections of molded articles along the resin flow direction. The molded articles are formed by actual molding carried out by the inventors using the molding apparatus shown in FIG. 6. In FIG. 7, an admixture of PC and ABS is used for both the first resin material and the second resin material. In FIG. 8, PC is used for the first resin material and an admixture of PC and ABS is used for the second resin material. The cross sections of the drawings are enlarged by 350 to 500 times. In both FIGS. 7 and 8, it is clear that a non-directed portion is formed in a bonding part of the first and second resin materials.

The entire disclosure of a Japanese Patent Application No. 2005-32455, filed on Feb. 9, 2005, including specifications, claims, drawings and summaries are incorporated herein by reference in their entirety.

What is claimed is:

1. A resin material molding method comprising:
equalizing flow speeds of a first resin material and a second rein material at a confluence of the resin materials when the first material and the second resin material are fed into a common cavity through different inlets, the cavity including a first mold and a second mold.

2. A resin material molding method comprising:
controlling a thickness ratio of a first resin material to a second resin material in a direction perpendicular to a flow direction by changing at least one of temperature, pressure and speed of the first resin material and the second resin material in a common cavity when the first resin material and the second resin material are fed into the common cavity through different inlets, the cavity including a first mold and a second mold.

3. The resin material molding method of claim 1, wherein the first resin material and the second resin material are a same material.

4. The resin material molding method of claim 2, wherein the first resin material and the second resin material are a same material.

5. The resin material molding method of claim 1, wherein the first resin material and the second resin material are different materials.

6. The resin material molding method of claim 2, wherein the first resin material and the second resin material are different materials.

7. The resin material molding method of claim 1, wherein the first resin material and the second resin material are any one of PC, ABS, modified PPE, PBT, PCABS, PCPBT, HIPS, polyamide, POM, PP, PMMA, COP and COC.

8. The resin material molding method of claim 2, wherein the first resin material and the second resin material are any one of PC, ABS, modified PPE, PBT, PCABS, PCPBT, HIPS, polyamide, POM, PP, PMMA, COP and COC.

9. The resin material molding method of claim 1, wherein the first resin material and the second resin material contain at least one of a glass fiber, a glass bead, and a carbon fiber.

10. The resin material molding method of claim 2, wherein the first resin material and the second resin material contain at least one of a glass fiber, a glass bead, and a carbon fiber.

11. The resin material molding method of claim 1,
wherein the different inlets are formed by dividing a single inlet with a partition plate, the single inlet being connected to the cavity,
the partition plate is cylindrical,
the first resin material flows through an inlet on a radial outer side of the partition plate, and
the second resin material flows through an inlet on a radial inner side of the partition plate.

12. The resin material molding method of claim 2,
wherein the different inlets are formed by dividing a single inlet with a partition plate, the single inlet being connected to the cavity,
the partition plate is cylindrical,
the first resin material flows through an inlet on a radial outer side of the partition plate, and
the second resin material flows through an inlet on a radial inner side of the partition plate.

13. A resin material molding apparatus comprising:
a first mold and a second mold for creating a cavity inside;
a first feed source for feeding a first resin material to the cavity;
a first passage for connecting the first feed source and the cavity;
a second feed source for feeding a second resin material to the cavity;
a second passage for connecting the second feed source and the cavity; and
a partition plate for dividing the first passage from the second passage before the cavity,
wherein the first resin material and the second resin material flow together at a position beyond the partition plate, and
the partition plate is provided so as to be displaced at least in a direction perpendicular to flows of the first resin material and the second resin material.

14. The resin material molding apparatus of claim 13,
wherein the partition plate is separated from the first mold and the second mold.

15. The resin material molding apparatus of claim 13,
wherein the partition plate is integrated with the first mold or the second mold.

16. A molded article in which a first resin material and a second resin material are bonded together,
wherein non-directed layers are formed at least in the second resin material facing the first resin material and in the first resin material facing the second rein material.

17. A molded article in which a first resin material and a second resin material are bonded together,
wherein three non-directed layers which are sandwiched by directed layers, are formed within the molded article.

18. The molded article of claim 16,
wherein the first resin material and the second resin material are a same material.

19. The molded article of claim 17,
wherein the first resin material and the second resin material are a same material.

20. The molded article of claim 16,
wherein the first resin material and the second resin material are different materials.

21. The molded article of claim 17,
wherein the first resin material and the second resin material are different materials.

22. The molded article of claim 16,
wherein the first resin material and the second resin material are at least any one of PC, ABS, modified PPE, PBT, PCABS, PCPBT, HIPS, polyamide, POM, PP, PMMA, COP and COC.

23. The molded article of claim 17,
wherein the first resin material and the second resin material are at least any one of PC, ABS, modified PPE, PBT, PCABS, PCPBT, HIPS, polyamide, POM, PP, PMMA, COP and COC.

24. The molded article of claim 16,
wherein the first resin material and the second resin material contain at least one of a glass fiber, a glass bead, and a carbon fiber.

25. The molded article of claim 17,
wherein the first resin material and the second resin material contain at least one of a glass fiber, a glass bead, and a carbon fiber.

26. The molded article of claim 16,
wherein the molded article has a film shape.

27. The molded article of claim 17,
wherein the molded article has a film shape.

28. The molded article of claim 16,
wherein the molded article is cylindrical.

29. The molded article of claim 17,
wherein the molded article is cylindrical.

30. The molded article of claim 16,
wherein the molded article is an optical element.

31. The molded article of claim 17,
wherein the molded article is an optical element.
